(19) United States
(12) Patent Application Publication
(10) Pub. No.: US 2008/0066155 A1
(43) Pub. Date: Mar. 13, 2008

(54) System And Method For Device-Based Content Range Authentication

(75) Inventor: Gerald G. Abraham, Saratoga Spring, NY (US)

Correspondence Address: BORDEN LADNER GERVAIS LLP;Gail C. Silver, 1100-100 QUEEN ST, OTTAWA, ON, K1P 1J9, CA

(73) Assignee: GABA HOLDINGS INTERNATIONAL, INC., Toronto, ON (CA)

(21) Appl. No.: 11/815,992

(22) PCT Filed: Feb. 10, 2006
(86) PCT No.: PCT/CA06/00194

§ 371 Date: Aug. 10, 2007

Related U.S. Application Data
(60) Provisional application No. 60/651,202, filed on Feb. 10, 2005.

(51) Int. Cl. H04L 9/00

(52) U.S. Cl. 726/3

(57) ABSTRACT

A system and method are provided for device-based, or appliance-based, authentication of a range of media files. The device itself becomes the controlled domain within a known universe, monitored by an access provider much in the way that access and throughput are measured through cell phone usage. The range of allocated files is tracked instead of attempting to track individual files, or the individuals who copy the files themselves. An access provider, such as a Telco, ISP, or Carrier, is used to authenticate ranges of playable files on a particular device, based on allowable fidelities. A partnership structure is also described including all industries involved with content distribution horizontally, between the industries starting from an access provider (Infrastructure), to a content provider (Artist, Producer, Distributor) and finally to a Chip Manufacturer (Device or Appliance).

### CROSS REFERENCE TO RELATED APPLICATIONS

This application claims the benefit of priority of U.S. Provisional Patent Application No. 60/651,202 filed Feb. 10, 2005, which is incorporated herein by reference.

### FIELD OF THE INVENTION

The present invention relates generally to media downloading. More particularly, the present invention relates to a system and method for device-based content range authentication.

### BACKGROUND OF THE INVENTION

The acquisition and distribution of multi-media content, such as music and video, has changed significantly with the increasing popularity of the Internet and of emerging peer casting technologies, as well as the increasing sophistication of consumer electronic devices. While this has resulted in a wider variety of convenient distribution and billing schemes, it has also increased the unauthorized acquisition and re-distribution of such media content.

There is broad recognition that the “downloading dilemma” is responsible for untold billions in quarterly revenue losses; hence, stakeholders in the content distribution business are attempting to minimize their losses. One approach is the use of “file-tracking” applications, known as Digital Rights Management (DRM) technology on as many user devices and appliances as possible. Those users would then be allowed to download specific content, paid for by specific vendors who opt-in to an alliance of companies (“Alliance”). The solution is no different than the authentication used on PCs, Laptops and other devices when registering and activating software applications after they are installed. This sort of technology is also used by companies for inter-office content transfer and validation from its source to authorized destinations.

A community can be considered those within inter-corporate businesses, or those who specifically purchase an application for use on a PC, Laptop or other device. Regardless of the worldwide sale of any software application, its user-base is considered vertical within a very specific domain. In any case, the domain will always be considered specific. However, there are differences in the case of applying the same file-tracking system to variables so dynamic and on a large scale against another variable, (e.g. those who distribute any multi-media related content). The implications and its scale are much greater when considering not only the universe of content being distributed, but also the universe of those who distribute massive amounts of multi-media content, whether it be for sale, demo or considered freeware by its creators.

Some proposed standards cause people to assume that their devices will only play music approved by the Alliance, in this case, the consumer electronics industry. Without taking into consideration the circumstances or context of downloaded content, this severely limits the use of user devices whose purpose is to play any multi-media content without context restriction or circumstances of its downloaded content. In other words, the Alliance assumes the consumer will only wish to acquire content from the Alliance meant for specific production and distribution made available only through official Alliance sales outlets. However, this fails to consider other multi-media content which may not have been created with the intent of official sales by a specific producer or distributor in mind. The result is the Alliance will spur unintended competition and create a lack of substantial consumer support.

The overall problem of illegal downloading is not really solved by such approaches as it does not take into account all industries' interests, leaving others to continue to either legislate, or spend untold millions of dollars in litigation, as the consumer specifically would not have the business' interests at heart.

Furthermore, artists and writers currently are wholly dependent upon a “pay-as-you-go” system of revenue provided through their producer's and distributor's networks. Those networks, albeit large to some extent, are vertically based, solely on their specific business relationships within their respective industries. Distributed content cannot however, guarantee payments to artists due to non-control of the content's custody. Therefore, the “universe” in which the lifecycle of content, (e.g. acquired, archived and distributed, by a potential customer) cannot guarantee that the customer will in fact maintain sole custody themselves or prevent redistribution of acquired content to others without payments or royalties remitted to the content's creators, producers or distributors. As a result, only a fraction of hundreds of millions of virtually downloaded music and video files are uncontrollably distributed.

It is, therefore, desirable to provide a media access solution that provides for authenticated downloads of media files that retains the simplicity of access of known solutions.

### SUMMARY OF THE INVENTION

It is an object of the present invention to obviate or mitigate at least one disadvantage of previous media access and distribution schemes.

In a first aspect, the present invention provides a method of content-range authentication in a communications network, including the following steps: authenticating a device to playback media content within an allowed playable range at a high fidelity; and allowing playback of content outside the allowed playable range at a low fidelity.

In further aspect, the present invention provides a system for device-based authentication and billing of media files. The system includes an access provider system. The access provider system itself includes: a memory for storing user contract data; authentication means for authenticating media content playback within an allowed playable content range based on the stored user contract data; and a billing module for billing a user based on the stored user contract data in advance of media downloads. The system also includes a content provider for providing a library of content to the access provider on a guaranteed revenue basis, unrelated to the media content being played by users. The system further includes a media player for allowing playback of content within an allowed playable range at a high fidelity, and for allowing playback outside the allowed playable range at a low fidelity.

In yet another aspect, there is provided a system for device-based authentication and billing of media files comprising at least one user device; at least one content provider; an access provider, in communication with said at least one user device and said at least one content provider; wherein said at least one user device transmits content requests to said access provider for content from said at least one content provider; and wherein after receiving said content from said content provider, said user device compares a content request number with a predetermined content request amount to determine if said content is played in a high or low fidelity.

In yet a further aspect, there is provided a method of content-range authentication in a communications network, comprising the steps of: receiving an authentication request from a user device associated with a user; authenticating said user; receiving a content request from said user; determining contract status of said user; transmitting requested content from a content provider to said user device to be played at a high fidelity if said contract status is currently active and to be played at a low fidelity if said contract status is expired.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 illustrates an overview of a first embodiment of a system for content range authentication and media distribution according to the present invention;

FIG. 2 illustrates a method of content range authentication and media distribution;

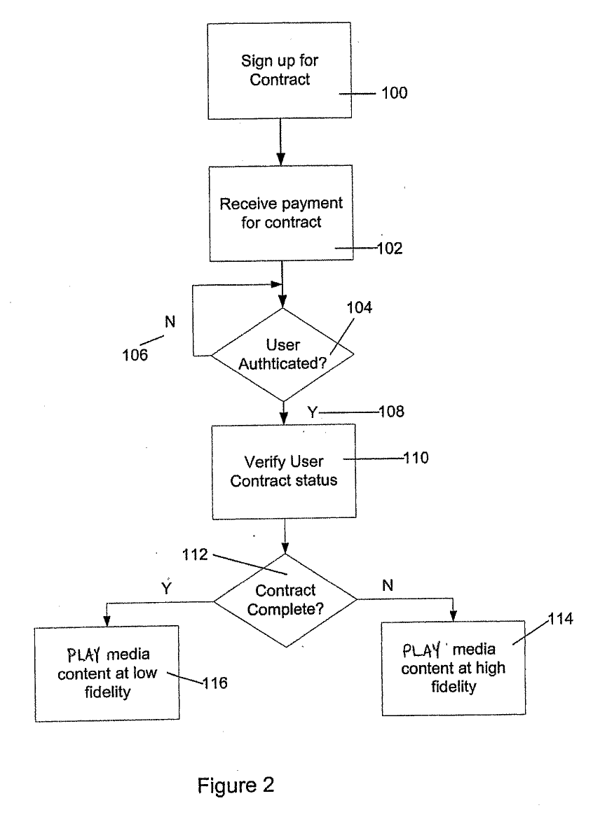

FIG. 3 illustrates an overview of a second embodiment of a system for content range authentication and media distribution;

FIG. 4 illustrates an overview of a system for content range authentication and media distribution according to an embodiment of the present invention;

FIG. 5 illustrates a basic business process workflow for a system according to an embodiment of the present invention;

FIG. 6 illustrates members and roles in a partnership system according to an embodiment of the present invention;

FIGS. 7A and 7B illustrate exemplary revenues based on known approaches and approaches according to embodiments of the present invention, respectively;

FIG. 8 illustrates a block diagram of a system according to an embodiment of the present invention; and

FIG. 9 illustrates the interaction of various components of a system according to an embodiment of the present invention.

### DETAILED DESCRIPTION

Generally, the present invention provides a method and system for device-based, or appliance-based, authentication of a range of media files. In the following description, a telephone company (Telco) is used as the access provider in the preferred embodiment, however, it will be understood that other types of access providers may be used where a Telco is described as being used.

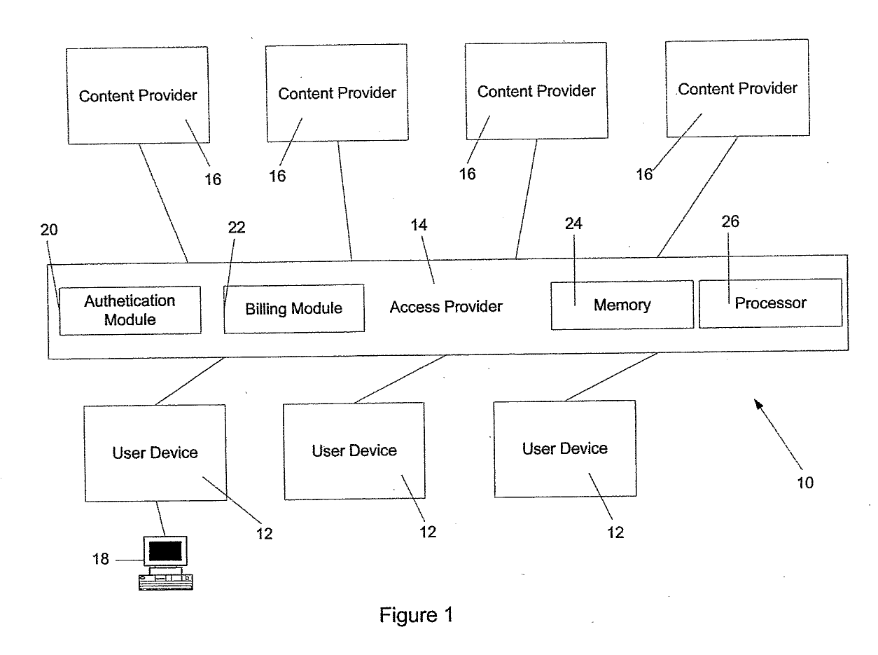

Turning to FIG. 1, a schematic diagram of a system for device-based content range authentication is shown. The system 10 comprises at least one user device 12 connected to an access provider 14 which, in turn, is connected to at least one content provider 16.

The user device 12 is used to communicate with the access provider 14 in order to access content, such as media files, from one of the content providers 16. This process will be described in more detail below. The user device 12 is preferably capable of playing the media content provided by the content provider 16, however, the user device 12 may also be used to direct the media content to a device capable of receiving and playing the media content, such as a computer 18, or a third party subscriber having access to the access provider 14.

The content provider 16 is typically a database which stores a library of media content for provision to the user device 12, via the access provider 14, when the content provider 16 receives such instructions from the access provider 14.

The access provider 14 preferably comprises an authentication module 20, a billing module 22, a memory 24 and a processor 26. The memory 24 stores user device information such as contract information while the authentication module 20 is used to authenticate a user and/or media content playback within an allowed playable content range based on the stored user contract data while the billing module 22 is used to bill a user (associated with the user device 12) based on the stored user contract data in advance of downloads of the media content from the content provider 16 to the user device 12. In the preferred embodiment, the access provider 14 may be a communications network, a Telco, an Internet Service Provider (ISP) or a carrier. The processor 26 is used to receive and transmit media content requests to the content providers 16 and to receive and transmit media content to the user device 12.

In operation, a user (associated with the user device) signs up for a contract with the access provider 14 enabling the user to access a pre-determined amount of media content from the content providers 16 (step 100). An example of this predetermined amount may be 1000 music files. The user contract information is then stored in the memory 24 of the access provider 14. If the user decides to pre-pay the contract, they will have instant access to the media content on the content providers 16, otherwise, the billing module 22 bills the user based on the user contract information. Other billing methods are contemplated but a full pre-payment is the preferred billing method.

After the payment for the contract has been received (step 102), the user may then access the media content via their user device 12. The user device 12 communicates with the access provider 14 to “log on” to the system, preferably by entering a user name and password in order to be authenticated (step 104). Another method of authentication is described in U.S. Pat. No. 6,941,454 entitled SYSTEM AND METHOD OF SENDING AND RECEIVING SECURE DATA WITH A SHARED KEY, which is hereby incorporated by reference.

If the user is not authenticated (step 106), the user must re-submit their authentication information (step 104). However, if the user is authenticated (step 108), via the authentication module 22, the access provider 14 verifies the user's contract status (step 110) to determine whether or not the contract has been completed (step 112) (whereby the user has already requested and received their predetermined amount of media content). If the user has not completed their contract, when the processor 26 receives the media content request, the media content request is transmitted to the associated content provider 16 and the media content is then transmitted to the user device 12 at a high fidelity (step 114). However, if the user has completed their contract, when the processor 26 receives the media content request, the media content request is transmitted to the associated content provider 16 and the media content is then transmitted to the user device 12 at a low fidelity (step 116).

In the situation where the user device 12 is a cell phone, the phone is used to be authenticated by the access provider 14 and once authenticated, may transmit a message to the access provider 14 to deliver or re-direct the media content to the computer 18 by providing computer identification information such as the IP address.

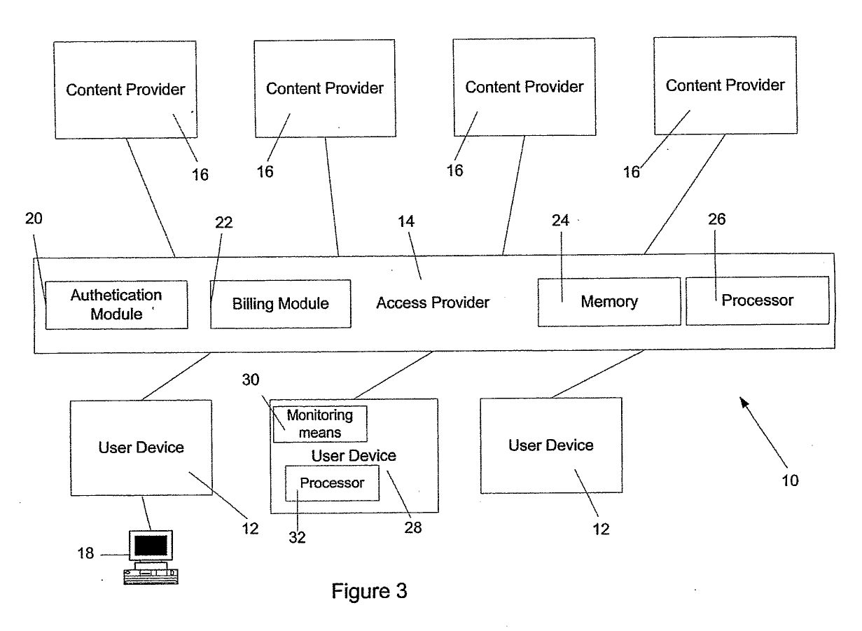

In another embodiment (as shown in FIG. 3), a user device 28 includes means for monitoring whether or not the user has completed their allocated downloads 30 so that the verification of the contract status is performed on the user device 12. Two examples of the means for monitoring are a chip within the user device or a software application module for monitoring the number of media content requests sent. Therefore, after the user has exceeded the predetermined number of media content requests, the means for monitoring 30 transmits a signal to a processor 32 in the user device 28 to play the media content (requested after the predetermined amount has been exceeded) at a low fidelity rather than a high fidelity. In yet another embodiment, after the 1000^{th} request has been sent from the user device 28 to the access provider 14, a time stamp is created so that any further media content received as a result of media content requests occurring after the time stamp are played in a low fidelity indicating that this media content was requested after the expiry of the contract or the user has reached their predetermined amount. In the preferred embodiment, the means for verifying the user contract status is stored within the user device 28 in the form of a chip.

In the preferred embodiment, once the user pays to renew their contract, the media content being played at the low fidelity may be played at a high fidelity such that if the user makes 500 more media content requests after their contract has expired but then renews their contract for another 1000 media content requests, all of the media content is then to be played at high fidelity.

If the user only renews their contract for 250 media content requests, only 250 of the 500 media files are converted to be played at high fidelity while the other 250 are be played at a low fidelity. In this case, in order to track the new high fidelity media content, the user may be provided the option to select the 250 which they wish to convert from low to high or the processor may simply select the media content received in first the 250 requests after the contract expired. In an alternative embodiment, the user may delete 250 previously downloaded median content files in order to have all the files played at a high fidelity. In this manner, the user's contract indicates how many media content files are allowed to be played at the high fidelity at a time on a user's device.

In one embodiment, whereby the contract verification is performed by the user device, the user device 12 controls the system and the playing of the media content. The user device is monitored by the access provider 14 much in the way that access and throughput are measured through cell phone usage. The range of allocated files is tracked instead of attempting to track individual files, or the individuals who copy the files themselves. The access provider 14 is used to authenticate ranges of playable files on a particular user device based on allowable fidelities. Therefore, a partnership structure may be achieved including all industries involved with content distribution horizontally, between the industries starting from an access provider 14 (Infrastructure) to a content provider 16 (Artist, Producer, Distributor). Moreover, this may also assist a Chip Manufacturer if the user device, such as a cell phone, includes a chip for the contract verification.

In general, the downloading universe comprises 4 parts which may be identified as: 1) The Infrastructure (access provider 14); 2) The Device or Appliance (user device 12); 3) The Consumer (user); and 4) The Content (media content from content providers 16). Unlike known approaches that only consider the problem from the perspective of the content or its consumer, embodiments of the present invention consider the problem from the perspective from the Infrastructure and/or Device.

Embodiments of the invention are directed at solving the downloading problem which will provide a benefit to the interests of all horizontal industries, without depending on any one specific technology. In other words, some embodiments of the invention consider the access provider to be the universe, and the user device to be the specific domain, unlike previous approaches which considers content to be the main focus. In the prior art, the device is used as the domain to track specific files themselves.

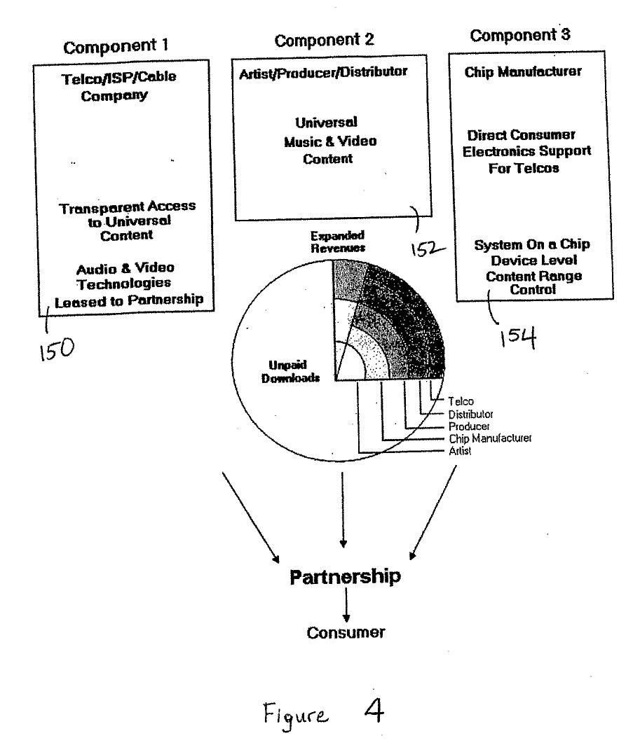

Another embodiment of the invention is shown in FIG. 4 which illustrates an overview of another system for content range authentication and media distribution. In this embodiment, the system, three components of the system are shown: an access provider system 150; a content provider system 152; and a media player including a contribution from a chip manufacturer 154. In the case of the Partnership of this embodiment, the devices (housing the media player) are not concerned with specific media content (in the form of files) but ranges of media content. To further explain, in the present embodiment, the access provider 150, or infrastructure provider, (i.e. communications network, Telco, ISP or Carrier) is used to authenticate ranges of playable files based on allowable fidelities.

In other words, if the access provider, such as a Telco, is pre-paid, a consumer contract allows that user's device to play a predetermined amount N of media content in an allowed playable range (e.g. 1000 music files). This media content will be played back at the highest original fidelity recorded, e.g. 96 kHz for audio or 24 bit color for video. This allows for the greatest amount and highest quality content transparently and automatically through any device e.g. cell phones registered with the access provider.

If the number of files exceeds the allowed playable range (e.g. 1000), all the media content received above the allowed range is played back at a minimal, or low, fidelity, e.g. 8 kHz for audio and 4 bit (16 color), 8 bit (265 color) or greyscale for video. The range of playable high fidelity content is determined by the consumer's contract. Anything exceeding the allowable range can be easily upgraded without concern for specific content's source of origin by simply renewing the contract. After the contract is renewed, a signal is transmitted from the access provider 150 to the chip insider the device to update the allowed playable range.

This approach works well since regardless of the reseller or distributor, the media content is transmitted past a registered ISP account if electronically downloaded, paid for, archived and eventually placed on some type of device. Firstly, for the industries 150, 152 and 154, the invention allows all industries involved with content distribution on a horizontal level to work together for each other best interests, starting from the access provider (Infrastructure), to the content provider (Content) and finally to the user device (Chip Manufacturer). Secondly, if the consumer pre-pays for as much media content as they wish in their contracts through the access provider, the access provider will then share in an entirely new on-going revenue stream.

With respect to a Chip Manufacturer, the chip set is not required to contain a specific file-tracking application based on a specifically held technology but will contain the best audio and video encoding/decoding technologies and coordinate the access provider's ability to track content throughput much in the way cell phone content and throughput is tracked. The Chip Manufacturer 154 also gets to sell many more chipsets included in all devices and appliances horizontally supporting the access provider 150 much in the same way the consumer electronics industry supports them now, instead of those chipsets vertically being deployed by specific consumer electronics companies not supported the access provider.

An advantage of the invention when the access provider is a Telco is that by using the Telco's wireless carrier infrastructure, more content and broadcasted content is available to every remote corner of the globe regardless of its geographic location, whereas Internet connectivity is not as accessible. It will be understood that this does not pit the Telco's wireless carrier infrastructure against the Internet, as convergence is of virtue and obvious benefit to all. However, by deploying existing authentication technologies the Telcos are already using, along with controlling ranges of playable high fidelity content, the consumer is provided the freedom to demo and download anything from any source desired.

The result takes into consideration all industries' interests, as well as the consumer's interests, by making the consumer a part of the solution right from the beginning instead of considering the consumer as part of the problem. Embodiments of the present invention also bridge the entire life-cycle of -media content across multiple complementary industries. Hence, by bridging or channelling the media content's entire distribution universe, such broad partnerships may realize an unprecedented advantage supporting the needs of artists and songwriters, while simultaneously providing producers and distributors revenue streams previously unavailable in current business models.

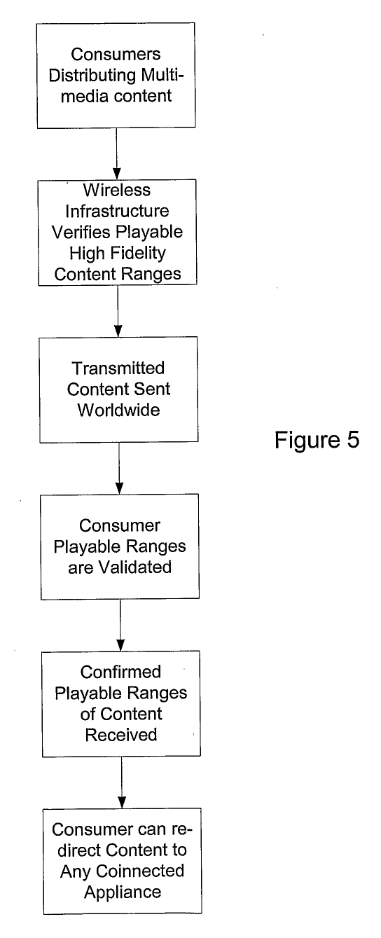

FIG. 5 illustrates an embodiment of a method according to the invention. The method is illustrated from the context of media content. The distributed media content represents a lowest common denominator within the three parts of the system of FIG. 4, namely: the access provider (telecommunications infrastructure); the content provider (multimedia content); and the user device (a media playing device). The end users interact with these components.

A method according to an embodiment of the present invention works within the framework of the three components. Together, the components afford new possibilities allowing company members to re-invent their revenue models while providing greater return-on-investment prospects. The access provider no longer has to rely on revenues stemming from individual accounts, but can increase their return on investment by providing revenues to content creators and distributors. In return, the content providers, associated with Artists, Producers and Distributors, provide a library of media content while increasing their return on investment.

The third component comprises of the consumer electronics industries and chip manufacturers who work closer together with the access provider and entertainment industries. Although alliances continue to be created, they are usually along very specific industry lines or thought of as vertical alliances.

Vertical alliances of companies within industries typically do not provide anything unique to solving the overall problem of illegal proliferation of content or intellectual property. However they continue to make the best possible attempt at protecting more specifically owned media content. By making the consumers themselves part of the solution instead of enforcing file tracking restrictions on the consumer and thus limit overall user device usage beyond the manufacturer's available content, the invention attempts to reduce the illegal downloading problems. Although proprietary format content selection is vast, their libraries can never compete with the universal access provided by SOCAN or ASCAP combined with direct support from the Artists, Producers and Distributors themselves.

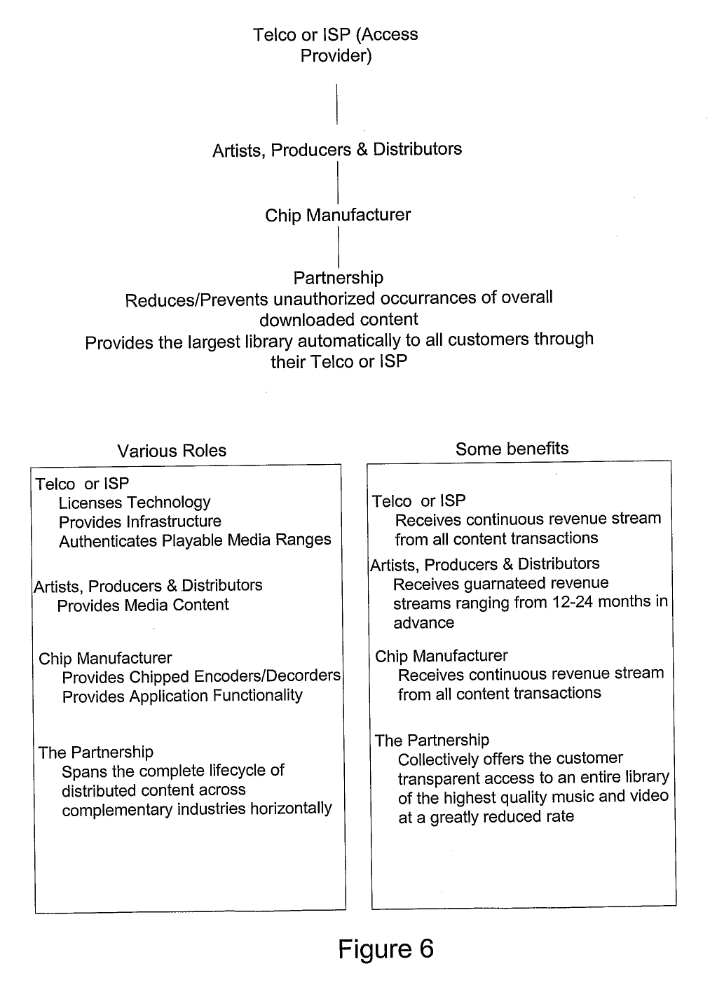

A partnership system according to an embodiment of the present invention provides a large horizontal infrastructure supporting real-time distribution and broadcasting of all media, e.g. multimedia, content. FIG. 6 illustrates components and roles in a partnership system according to an embodiment of the present invention.

The access provider (or infrastructure provider, not only participates, but enables individuals representing the content providers and the chip manufacturers to participate in the media content distribution chain. The access provider 150 transparently facilitates the use of technologies to all customers and license technologies by specific needs, such as: VoIP support and services; broadcast video technology; audio technology supporting entertainment and messaging content; required “know how” to embed unique signature date into digitized photos, documents, bank cheques, medical charts and records; real-time wireless video telecommunications; acquiring commonly used hardware, appliances, or consumer electronics devices; and entering into a universal content distribution chain themselves.

Though all three components of the system employ core audio and video technologies, one approach is to license those technologies through the access provider so the access provider may own or have exclusive rights to the technology. The partnership could own the technologies too; however, the partnership preferably ends up controlling the overall usage of the technologies in the end. Licensing will then come from the access provider to the chip manufacturer allowing the music distribution industry and end users to enjoy the benefits accordingly. The technology can then be transferred to the chip manufacturer component of the partnership for application integration. The access provider, or Telco, typically contributes infrastructure, audio/video encoders used by the chip manufacturers, and wireless and connected authentication of allowable content ranges.

The access provider preferably provides many advantages such as licensing state-of-the-art audio and video technologies to many industries as a means to generate more partnerships; providing a single source cell-system and cable content distribution infrastructure to large amount of customers or the leadership in providing a large country, continent or worldwide partnership. Other advantages include the opportunity to attain a “foot-hold” and broaden the access provider's customer base throughout various markets.

The access provider can also be thought of as a “conduit” that can provide some or all of the following exemplary services: infrastructure or conduit; content creation, production and distribution; deployment and use of consumer electronics devices and appliances. Exemplary partnerships including the access provider 150 in FIG. 4 may include any number of residential, mobile or other telecommunications service providers.

The content provider also provides various advantages such as providing access to vast amounts of audio and video content; providing an existing customer base in various markets; the opportunity to remove “hard-media”, e.g. CDs/DVDs from their distribution chain and the opportunity to increase direct-revenues for their artists, and thus maintain a large cache of intellectual property in the music distribution business.

Exemplary partnerships supporting the content provider 152 may include: music and entertainment associations and their creators; music and entertainment producers and distributors; news broadcast and cable companies; radio and satellite radio; eLearning and education institutions; health care and related businesses; insurance companies; banks and lenders; governments and their associated authorities; and security and surveillance.

The provider of the user device, or a chip manufacturer that provides components to be used in the user device, typically provide audio/video encoder/decoder chip sets, as well as consumer based applications deployed within cell phones, devices and appliances. The chip manufacturer may also provide a large distribution of hardware chips around the world; a customer base that also includes large telephony and data switching companies, as well as most cell phones and consumer electronics devices; a direct-home gateway project related to a venture providing multi-media in every home around the world and/or an audio and video technologies chip supporting VoIP, real-time video conferencing, broadcasting, archiving and downloading of multi-media content.

Exemplary partnerships supporting the chip manufacturer, or chip device include: software developers; consumer entertainment electronics companies; chip manufacturers; computer re-sellers, OEMs and VARs; cellular or mobile phone and video camera manufacturers; eDocument producers and distributors; an automobile manufacturers.

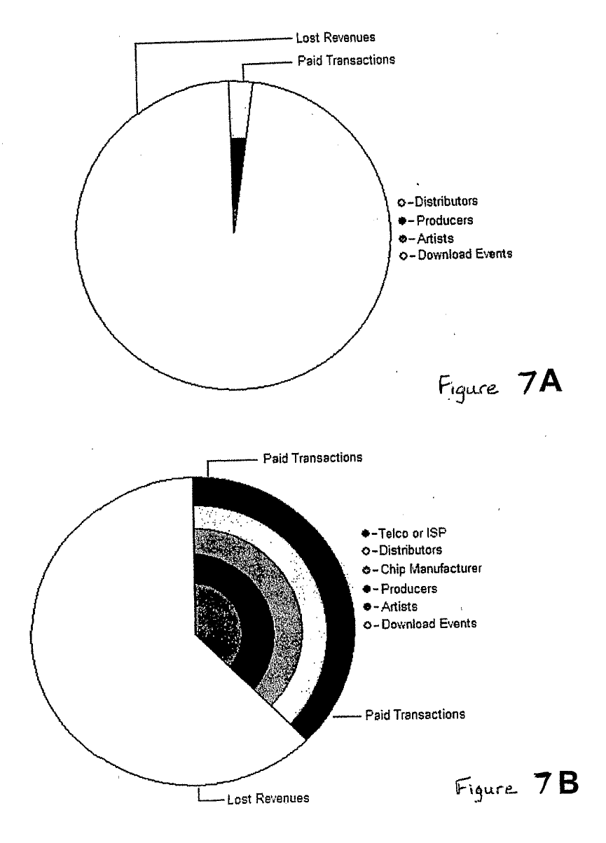

Acquiring the audio and video technologies of the invention presents a principle advantage to the Partnership to provide a competitive advantage for each company who become a component of the system. Every company representing each of the parts of the system jointly realize greater shares of on-going revenues due to the set up of the system. FIGS. 7A and 7B illustrate exemplary revenues based on known approaches and approaches according to embodiments of the present invention, respectively. As is evident, not only is the “piece of the pie” larger according to embodiments of the present invention, but there are more stakeholders benefiting from the revenues realized from downloaded content.

In the invention, since Artists, Producers and Distributors are preferably provided with multi-year revenues from the access providers, a new negotiating mechanism is created. Through joint cooperation, complementary industries supporting content in one fashion or another can share in a much greater portion of the total daily download event.

An advantage of the invention is that artists, producers and distributors can control the distribution of the media content by virtue of existing technology used everyday by the Telco. By allowing the Telco to share in the distribution royalties, the Telco has an incentive to offer their infrastructure, along with additional technologies to prevent or inhibit a customer's propensity to freely distribute licensed content. However, this is accomplished transparently by offering the customer incentives via their Telco's infrastructure providing unlimited library access, featuring ranges of playable pre-paid high fidelity audio or video access. Authentication occurs through a numbered range of high fidelity archives on the consumer electronics device or appliance registered with the Telco's wireless services.

Regardless of the user device's ability to store tens of thousands of audio files or hundreds of video files, only a specific range of files are allowed to be played at their highest recorded fidelity. For example, if the customer has a pre-paid monthly allocation of 1000 files archived on a specifically provided consumer user device such as a computer or a cell phone, and the customer acquires 3000 files, the remaining 2000 audio files will play back at monotone, or low, fidelity.

Regardless of whether or not the user plays one file at a time, only the first 1000 files are usefully played back at its highest recorded fidelity, regardless of the device's repository capacity. The user would be required to delete from menu options, any of the remaining 2000 files, regardless of their order, but only if the number of files doesn't exceed the allotted range.

The customer could however upgrade to a greater allotted range of playable high fidelity files simply by providing payment for this greater allotment to an access provider or other transactions method. This may simply be achieved by an authorized payment plan or by scrolling through a menu of features provided by the access provider on the user device. The user is then billed in accordance with their monthly invoice, which is preferably amortized in a contract, thus amounting to a minimal charge to the customer. This further contributes to a greater guaranteed revenue source to the artist, producer and distributor associated with the content providers.

The chip manufacturer supports the system through the Telco or ISP's infrastructure authenticating and controlling the playback range of each customer's wireless or connected device and appliance via the encoder/decoder supporting next generation audio and video technologies.

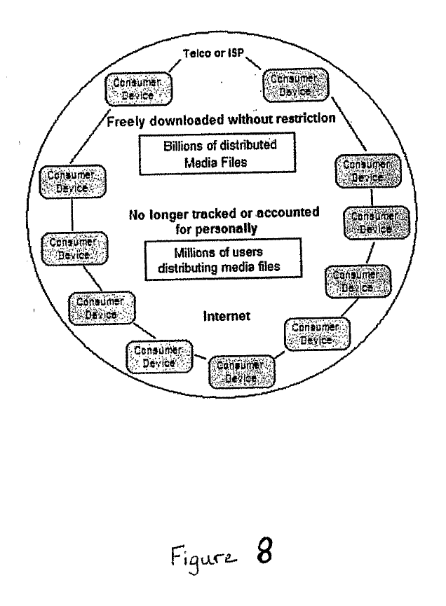

FIG. 8 illustrates a block diagram of another system according to an embodiment of the present invention for device-based (or appliance-based) authentication of a range of files. The user device is monitored by the access provider in a manner similar to the way that access and throughput are measured through cell phone usage. The range of allocated files is tracked instead of attempting to track individual files, or the individuals who copy the files themselves. An access provider, such as a Telco, ISP, or Carrier, is used to authenticate ranges of playable files on a particular device, based on allowable fidelities.

As described above, the range of playable high fidelity content is determined by the user's contract, though the device has unlimited access to the media content stored in the content providers via the infrastructure of the access provider. Anything exceeding the allowable range is only available to be played at a low fidelity, but can easily upgraded without concern for the specific source of origin of the media content. Such upgrading can easily be performed via menu-based selections, and billed in accordance with the user's monthly invoice. A Chip Manufacturer's chipset preferably coordinates the access provider's ability to track content throughput much in the way that cell phone content and throughput are tracked. Since the authentication scheme is independent of the media encoding/decoding technology used, the most efficient and up-to-date media encoding/decoding technologies can be used, and the user is not restricted to the use of particular technologies.

A system according to an embodiment of the present invention validates transmitted media content from its content providers to any user device serviced by the access provider's transmission infrastructure.

A system according to an embodiment of the present invention can additionally employ a peer casting technology, such as a super-peer technology. An example of such a technology is currently known as the BitTorrent peer casting infrastructure. Essentially, peer-to-peer file sharing networks allow broadband providers to provide access to their users at superfast rates, while uploading is limited to a slow rate, creating a bottleneck. A peer-casting infrastructure basically divides a file up into small pieces, and provides the pieces to several uploaders. A user's computer can search around for pieces of desired media content, and download the pieces separately from various sites, in much less time than it would take to download the entire file from a single site. Since embodiments of the present invention limiting audio or video fidelity by virtue of a range of pre-paid and allotted archives at the device domain, most any peer casting infrastructure can be duplicated and used, for example in an access provider's cable set top boxes. This flexibility springs from the fact that this approach is largely technology-independent. Therefore, the content provider may also be an individual's computer since the system is not concerned with where the media content is received from but the number of media content request transmitted by a user device.

One of the keys to validating playable high fidelity content via wireless consumer electronics is by using existing technologies which Telco's currently deploy, to validate cell phone and text message usage. In short, there are two categories of technologies which are instrumental to overall “range-content” tracking. One category of technologies are commonly used to track communication Input/Output (I/O) through the Telco's wireless infrastructure, while the other category of core technologies is based on audio and video encoding and decoding.

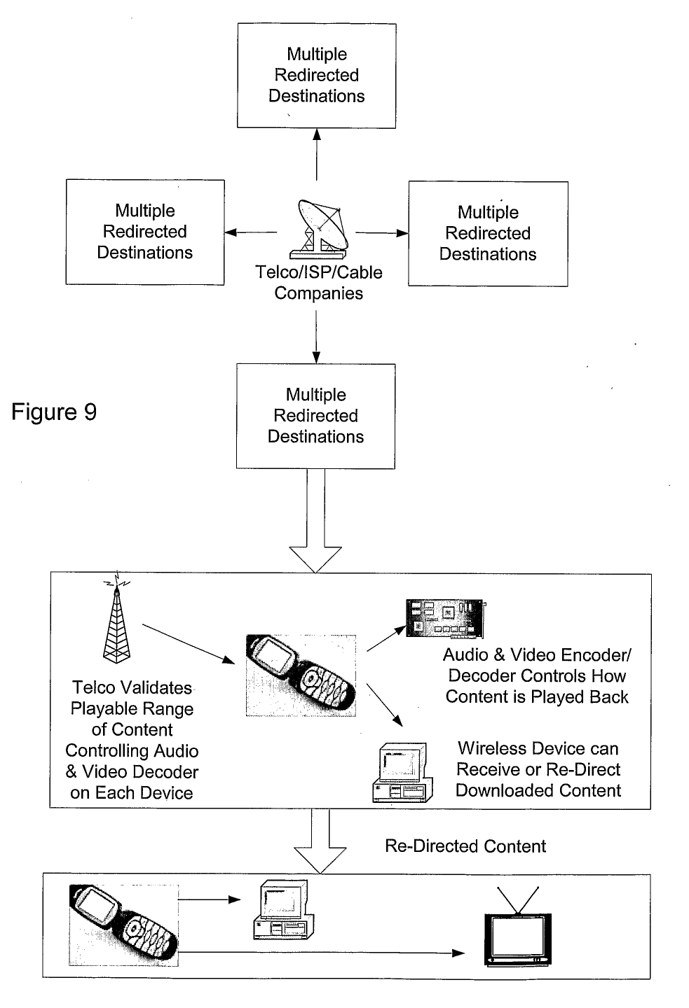

Just as Flash read-only memories (ROM) in wireless devices are used to hold information unique to each device, the wireless communication infrastructure is used to validate usage activity for billing purposes for the Telco. However, while content is being downloaded, whether archived locally or re-directed to a remote device accessed by the Telco, only those files which fall within the range of pre-paid content are played back at their original fidelity. Such re-direction is shown in FIG. 9, which illustrates the interaction of various components of a system according to an embodiment of the present invention.

Any content exceeding pre-paid limits is played at 8 kHz mono or 8-bit grayscale, or low, fidelities, as there is no download limitation or restrictions as to the content's source. On the surface, shuffling content to meet pre-paid fidelity ranges could be seen as a drawback. However, the overwhelming access to media content universally, coupled with extraordinarily low costs of monthly pre-paid features and benefits, amortized over multi-year contracts gives the consumer little reason to constantly re-shuffle content versus upgrading their pre-paid ranges.

With respect to the access provider's system, an arrangement according to an embodiment of the present invention provides many advantages. The partnership as described herein may expand revenue streams based on new partnerships and distribution of content—partnerships which make it possible to enter new territory “combining market spaces” starting with wireless transmission and Internet infrastructures, to the production, distribution and dissemination of content, and finally, influencing the core technology itself incorporated directly into appliances or devices by which the consumer ultimately receives such content.

Media content, such as multimedia content, may include, but are not limited to, audio music files, video files, streamed news shorts, streamed sports shorts, public or official announcements, real-time wireless televideo.

The media-playing user device may be any device capable of playing media content. Examples include, but are limited to, hybrid mobile telephones, set top boxes, portable audio and video players, home theatre and stereo systems.

In a preferred embodiment, maturing technologies, coupled with feature-rich convergence of applications, makes the cell phone the preferred user device to send, receive and re-direct any multi-media content. Other devices capable of playing the media content can receive data embedded in automobiles, devices in airplanes, laptops, desktops, hybrid PDA/cell phones or smart-homes and offices may be the recipient of the re-directed media content. Any device connected to the Telco's service can re-direct content from its menu-based interface to any other device in communication with the access provider.

In operation, from the cell phone or other wirelessly connected hybrid device, the user is preferably presented with a series of menus providing them with the ability to customize their interface with any category of music, video or specific artists preferred. Much the same way other distributors offer music or video content over the Internet, the user is then presented with only that media content meeting the desired condition.

The result is that the consumer can listen to any terrestrial or satellite radio and automatically see the music or video being displayed in the menu interface in real-time. This is due to the radio broadcast company's distribution of music within the Telco's wireless infrastructure. Whatever the broadcast company is playing is offered to the Telco's customer base simultaneously.

Another advantage of an embodiment of the invention is that little or no modifications or special information is required in the media content file. The fidelity of the music archive is limited during playback by a chip in the user device. The reduction of music fidelity typically occurs through the audio technology's decoder chip within a device's embedded software decoder, which reduces the fidelity regardless of what or how the original music content file was recorded.

For those user devices containing the software decoder chip, the user device itself can be authenticated either by the ISP through a paid account or certificate file, otherwise the music archive will only play back at low fidelity, or monotone. If the device is not connected to the Internet through the ISP at the time the file was downloaded, a certificate should be copied in the way any other file is copied certifying that the player can play a “certain number or range” of music files at the file's fullest recorded fidelity. The authorization of the device occurs once connected to the Internet. If the device is off-line, the certificate is automatically copied, authenticated and maintained in a Flash ROM within the device, allowing the device to play a specific number of files at the highest fidelity of the original recording.

Certificates can come from multiple vendors as well as the ISPs themselves. Depending on source, authentication permission increases the number of files played at its highest fidelity, but not concerned with specific music or media files themselves. In other words, in an embodiment of the invention, it is the user device which is authenticated, one way or another, via a direct internet connection, or a certificate increasing the number of music files played back at high fidelity. If the consumer downloads additional music on the device without authentication or by providing a certificate increasing the number of playable music files at full fidelity, only the authorized number is played back at high fidelity. The remaining files are played back at low fidelity. The user is free to decide which music files are played at high fidelity and which can only be played in monotone. Hence, the music industry is no longer concerned with actual numbers of downloaded music files or those who “download”, as the devices which play the files are themselves registered based on monthly or annual pre-payments through the ISPs, much in the same manner cell phones are continuously monitored for payment.

In further alternative embodiments, two new audio technologies which will bring to bear new competitive advantages. The first audio technology is completely MP3 compatible but more efficient. The second audio encoder is approximately 50% more efficient than commonly available MP3 audio technology. Both technologies compress audio in real-time without any loss of fidelity. From the perspective of the consumer, these efficiencies have little effect on overall storage capacities of the day due to low cost archive space. However, from the perspective of the wireless carrier or Telco, a 25% to 50% reduction in overall transmission requirements to send the same amount of content provides a cost savings play-on-the-margins few can argue with.

The second technology variant supports VoIP applications and allows for a much smaller bandwidth connection, e.g. less than EDGE or much less than 115 kbps, but providing audio well within stereophonic ranges.

By using the new technologies, the following advantages are realized. Minimal wireless connection ranging from 50+ kilobits supporting stereo fidelity and 9 kbps supporting 6-8 kHz ranges or mono and audio frequencies can be supported providing functionality controlling specific audio frequencies, e.g. 8 kHz-10 kHz, 20-30 kHz, 30-97 kHz, depending on the application. Also, in circumstances involving minimal connectivity, e.g. 9-25 kilobits, greater audio frequency can be provided more efficiently than current technologies. The core technology is platform agnostic. The average compression is conservatively 50% better than existing audio compression technologies. Applications features can provide features reducing extremely high or low frequencies from conversations, e.g. if the male or female human voice is at a certain kHz range, ambient audio noise be extracted, or an application feature built-in to allow the user to limit external audio noise to within certain kHz ranges. This is useful for airports, within airplanes, wind noise from within cars, trains, restaurants, or noisy theater of operations. All signalling protocols can be used to apply the codec technology. Users can carry on many-to-many, point-to-point conversations, much in the same way analog conversations occur. The system is easy to incorporate an efficient encryption algorithm into the codec. Codec can provide error handling allowing tools to be developed to provide network WANs or Enterprises voice-specific metrics, e.g. determining quality of audio throughput kHz ranges. Audio archives can be “real-time” converted to any other format commercially supported. The time required to “Chip” the codec into preferred hardware is estimated to be about 8-10 weeks.

Another advantage is that the system is executed via software modules which are written, or programmed “from the ground up” providing applications supporting real-time wireless video telecommunications, broadcasting along with the ability to provide many more products and services than ever before.

Advantages in video features using the new technologies are also realized. These advantages include real-time 24-bit color at 30 frames per second at CIF, QCIF or super-CIF video frame heights or widths supporting the majority of wireless handheld displays; next-generation H.264 video compression results in half the typical MPEG file size and twice the fidelity; H.264 video compression technology applies seven different macro-block sizes for improved motion compensation; H.264 video compression technology adopts a superior motion compensation methodology for higher flexibility and efficiency over conventional legacy MPEG Codices; H.264 video compression technology improves improved de-blocking filters; H.264 video compression technology supports temporal spatial prediction across a range of frames or within each frame separately; H.264 video compression technology achieves a high process speed by using whole integer based algorithms; H.264 video compression technology specifies motion vectors to ¼ pixel accuracy; H.264 video compression technology dramatically reduces blocky artifacts typically seen in MJPEG or MPEG codices; H.264 video compression technology allows HD video to be archived on one DVD, with room to spare for additional producer content, whereas current HD compression requires at least 3 DVD's; H.264 video compression technology maintains the fidelity of each frame at an extremely high compression ration by utilizing superior edge detection techniques, while saving overall bandwidth. Additional improvements include a 30%-40% reduction of existing MPEG 2 or MPEG 4 video without any loss of fidelity, thus providing a longer transition from legacy video codec technology to the next-generation H.264 which reduces up-front hardware or software replacement costs to the infrastructure.

Video-shorts broadcasting, up-to-the-minute sports and local & international news in real-time can be a reality within the currently owned EDGE 174 kb wireless infrastructure. By integrating the chipsets into hybrid cell phones or other connected appliances affords consumers a universal and transparent access.

Another advantage is video-casting to wireless appliances any time, anywhere.

Another advantage is that concert promotions can be transacted in a similar manner. However, in the case of the concert event, the artist's music CD or DVD can be made available to the ticket purchaser at a discounted rate just prior to, and for a short time after the event is concluded. The artist's latest CD or entire library can automatically be displayed in the hybrid phone's menu interface made available for additional purchases, and billed to the consumer's wireless monthly account.

As described above, the access provider, such as Telcos/Carriers/ISPs, provides infrastructure, universal access to consumer content, purchases and re-licenses core technologies and provides content validation and guaranteed revenues to other industries. The access provider can receive on-going revenue streams from downloaded or broadcasted content. The content provider, associated with Artists/Producers/Distributors, provides content, as well as provides the access provider with access to an established base of consumers. The content provider can receive guaranteed multi-year revenue streams from the access provider. A chip maker, or electronics manufacturer or service/design provider, provides consumer hybrid device features, incorporates audio and video encoders, along with an additional application provided exclusively to the access provider, and their own customer base. The chip maker can receive on-going revenue streams from downloaded or broadcasted content and additional sales of its chips integrated into consumer electronics devices and appliances. Media player users provide consumer multi-year contracts to the access provider, and can receive automatic access to universal content at a vastly reduced cost. Third party industries, e.g. automobile, food product, governments, or other services, also provide consumer multi-year contracts to the access provider. In return, the third party industries can receive automatic access to universal content at a vastly reduced cost supporting their marketing or public relations efforts.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method of content-range authentication in a communications network, comprising:
authenticating a device to playback media content within an allowed playable range at a high fidelity; and
allowing playback of content outside the allowed playable range at a low fidelity.

2. A method of content-range authentication in a communications network, comprising the steps of:
receiving an authentication request from a user device associated with a user;
authenticating said user;
receiving a content request from said user;
determining contract status of said user;
transmitting requested content from a content provider to said, user device to be played at a high fidelity if said contract status is currently active and to be played at a low fidelity if said contract status is expired.

3. The method of content-range authentication of claim 2 further comprising the step, occurring before said step of receiving said authentication request, of:
storing contract information in a memory.

4. The method of claim 3 wherein said step of determining comprises the steps of:
comparing a number of content requests with a predetermined number of contact requests in said contract information;
wherein if said number of content requests is lower than said predetermined number of contact requests, said contract status is currently active.

5. The method of claim 2 further comprising the step, after said step of receiving a content request, of:
assigning a content request time stamp to said content request.

6. The method of claim 5 wherein said set of determining comprises the steps of:
creating a contract expired time stamp after a predetermined number of content requests have been issued; and
comparing said contract request time stamp with said contract expired time stamp;
wherein if said contract request time stamp is before said contract expired time stamp, said contract status is currently active.

7. The method of claims 2, 4 and 5 further comprising the steps of:
receiving notification that the contract status has been changed from expired to currently active; and
playing said low fidelity content at a high fidelity.

8. A method of content-range authentication in a communications network, comprising the steps of:
transmitting an authentication request to an access provider;
after receiving authentication authorization, transmitting a content request to said access provider;
monitoring a total number of content requests;
comparing said total number of content requests with a predetermined amount of content requests;
receiving said requested content;
playing said content at a high fidelity if said total number of content requests is less than or equal to said predetermined amount of content requests and at a low fidelity if said total number of content requests is greater than said predetermined amount of content requests.

9. The method of claim 8 further comprising the step, occurring after said step of receiving said requested content, of:
re-directing said requested content to a third party subscriber.

10. The method of claim 8 further comprising the step of:
receiving an updated predetermined amount of content requests;
comparing said total number of content requests with said updated predetermined amount of content requests;
wherein if said updated predetermined amount of content requests is greater than said total number of content requests, playing said low fidelity content at a high fidelity.

11. A system for device-based authentication and billing of media files, comprising:
an access provider system including:
a memory for storing user contract data;
authentication means for authenticating media content playback within an allowed playable content range based on the stored user contract data;
a billing module for billing a user based on the stored user contract data in advance of media downloads;
a content provider for providing a library of content to the access provider on a guaranteed revenue basis, unrelated to the media content being played by users; and
a user device for allowing playback of content within an allowed playable range at a high fidelity, and for allowing playback outside the allowed playable range at a low fidelity.

12. A system for device-based authentication and billing of media files comprising:
at least one user device;
at least one content provider;
an access provider, in communication with said at least one user device and said at least one content provider;
wherein said at least one user device transmits content requests to said access provider for content from said at least one content provider; and
wherein after receiving said content from said content provider, said user device compares a content request number with a predetermined content request amount to determine if said content is played in a high or low fidelity.

13. The system of claim 12 wherein said at least one device comprises a chip for determining if said content is played in a high or low fidelity.

14. The system of claim 12 wherein said access provider further comprises:
an authentication module for authorizing access for said at least one user device to said at least one content providers;
a memory for storing user contract information; and
a billing module for billing a user based on said user contract information.

15. The system of claim 14 wherein said contract information includes information such as a predetermined number of content requests allowed.
